(19) United States
(12) Patent Application Publication
(10) Pub. No.: US 2005/0033700 A1
(43) Pub. Date: Feb. 10, 2005

(54) Method and apparatus for creating and rendering an advertisement

(76) Inventors: Dean H. Vogler, Algonquin, IL (US); Douglas A. Kuhlman, Inverness, IL (US)

Correspondence Address: MOTOROLA, INC., 1303 EAST ALGONQUIN ROAD, IL01/3RD, SCHAUMBURG, IL, 60196, US

(21) Appl. No.: 10/634,092

(22) Filed: Aug. 4, 2003

(51) Int. Cl. G06F 17/60; H04K 1/00; H04L 9/00

(52) U.S. Cl. 705/57; 705/14

(57) ABSTRACT

A method and apparatus for linking an advertisement and digital content are provided herein. The linkage is such that any attempt to render the desired digital content must first render the advertisement before the digital content can be accessed. The procedure is typically to prepend the advertisement to the digital content and to use a hash of the advertisement as a Content Encryption Key (CEK) which is needed to decrypt the digital content.

### FIELD OF THE INVENTION

The present invention relates generally to advertisements and in particular, to a method and apparatus for forcing an application to render an advertisement.

### BACKGROUND OF THE INVENTION

Oftentimes digital content is provided to users containing advertisements. The inclusion of advertisements with the digital content could allow providers to offer the digital content to the user at a reduced price compared to a version of the digital content without advertisements. For example, web sites often provide banners, popup windows, pushed audio and video, . . . etc. to viewers of their web pages. This allows the web site to be provided to the user at a much reduced cost (often for free).

One issue with regards to advertising is the proliferation of devices that can bypass advertising. For several decades, users were able to fast-forward the advertising recorded on VHS machines. Now, with TiVo® and Replay TV® users can even set up the machines to entirely leave off the advertisements from programs, making the job of bypassing advertisement complete and automatic. In the world of the internet, advertising on Web sites is easily bypassed or ignored. Popup windows can be killed by a number of widely available programs. Other programs can filter out audio & video from advertising sources, in addition to filtering email. As a result, advertisers generally do not know how effective their advertising is, as it can be easily programmed out, filtered, or simply ignored. Therefore a need exists for an advertisement and a method and apparatus for rendering an advertisement that greatly increases the chance that the advertisement will be viewed by the user.

### BRIEF DESCRIPTION OF THE DRAWINGS

FIG. 1 is a block diagram of a communication system in accordance with the preferred embodiment of the present invention.

FIG. 2 is a flow chart showing operation of the content provider of FIG. 1.

FIG. 3 is a flow chart showing operation of the user equipment of FIG. 1.

### DETAILED DESCRIPTION OF THE DRAWINGS

To address the above-mentioned need, an advertisement, along with a method and apparatus for rendering the advertisement is provided herein. The advertisement message is typically prepended to the digital content requested by a user (however, the advertisement can appear anywhere, as long as the desired digital content is after the advertisement), and contains a Content Encryption Key (CEK) that is only obtainable after rendering the entire advertisement. The CEK is needed to decrypt the digital content.

Because the CEK can only be obtained by rendering the advertisement, bypassing, skipping, or modifying the advertisement will make it impossible to view the digital content included with the advertisement. Therefore, a user must completely render the advertisement message in order to view the digital content.

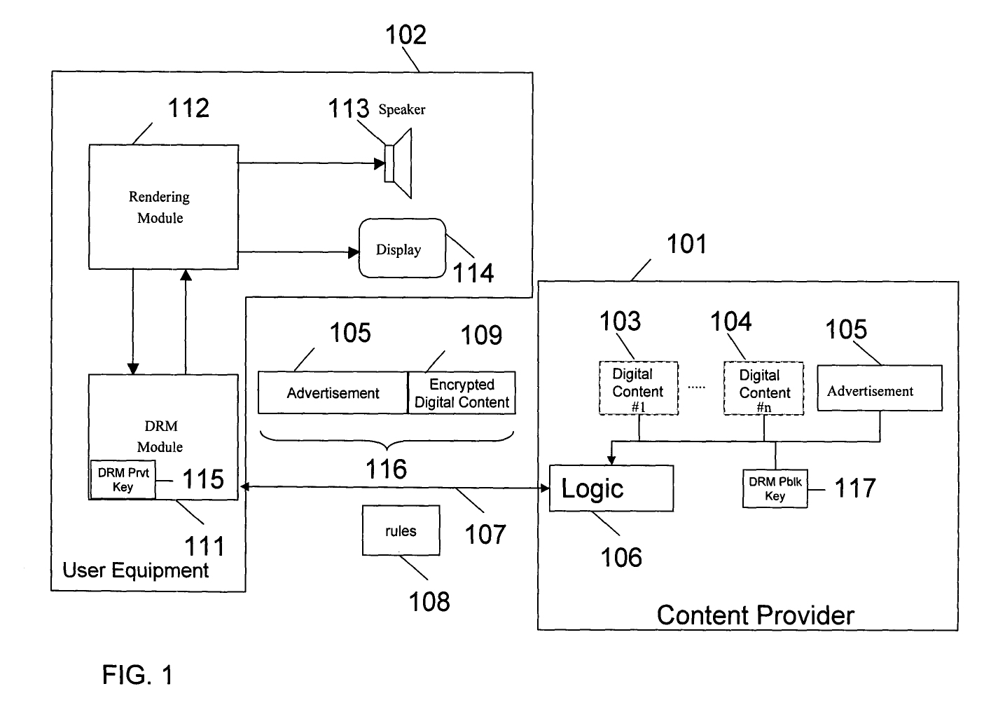

Turning now to the drawings, wherein like numerals designate like components, FIG. 1 is a block diagram of a file-sharing system in accordance with the preferred embodiment of the present invention. The file-sharing system of FIG. 1 utilizes Digital Rights Management (DRM) in order to securely share files between devices. As one of ordinary skill in the art will recognize, Digital Rights Management is a popular phrase used to describe such protection of rights and the management of rules related to accessing and processing digital items. Content owners hope to protect their valuable digital content using a DRM system that is implemented by secure, tamper-resistant electronic devices.

The file sharing system of FIG. 1 comprises content provider 101, and user equipment 102. User equipment 102 may be a personal computer equipped with an application (rendering module 112) to “play” an MPEG Audio Layer 3 (MP3) file or any other digital content. Similarly, user equipment 101 may comprise a cellular telephone equipped to play an MPEG Video Layer 4 file with a standard MPEG video codec. Other possible embodiments for user equipment 102 include, but are not limited to, set-top boxes, car radios, networked MP3 players, Personal Digital Assistants, stereos, DVD players, . . . , etc. Other possible embodiments for digital content include, but are not limited to music, games, videos, pictures, books, maps, software, ringtones, wallpaper, screen savers, personalized news, sports scores, . . . , etc.

As is evident, user equipment 102 comprises DRM module 111, and rendering module 112. Content provider 101 comprises digital content 103-104 for distribution along with at least one advertisement 105. Logic circuitry 106, which preferably is a microprocessor/controller, serves to format digital content 103-104 and advertisement 105 for transmission to user equipment 111.

When a user wishes to access digital content 103-104, DRM module 111 provides the request to content provider 101. Content provider 101 then prepares file 116 to transfer to DRM module 111 along with rules file 108. File 116 comprises at least one advertisement message 105 prepended to encrypted digital content (e.g., encrypted digital content 109). Rules file 108 comprises instructions needed for properly obtaining the CEK along with other DRM rules (e.g., play once, read only, . . . , etc.). The digital content 103 is encrypted with the CEK to become the encrypted digital content 109. The CEK is “embedded” within the advertisement and derived from properties of the advertisement message 105 that are attainable only when the advertisement message 105 is completely processed (or rendered). Transmission of the file may take place over networks of various forms such as but not limited to a cellular network, a local-area network, a wide-area network, phone line, written media (like a CD), memory card, . . . , etc. For example, user equipment 102 may comprise a standard cellular telephone, with network 107 comprising a cellular network such as a code-division, multiple-access communication system.

Once received by user equipment 111, DRM module 111 analyzes rules file 108 to determine rights available for the digitial content. In order to render the digital content, first, advertisement 105 is rendered in its entirety by DRM module 111 to derive the CEK. The CEK is utilized for decrypting digital content 109. Digital content 109 then sent to rendering module 112 where it is appropriately rendered utilizing display 114 and/or speaker 113.

In an alternative embodiment, no rules document is required. A de facto set of rules governing the entire system are in place. These rules would allow unlimited play of properly licensed files. Even without advanced rules, the present invention allows for the required playing of the advertisement. In this embodiment, all rules are assumed to apply universally across all received content.

It should be noted that there exist several techniques for incorporating the CEK into advertisement 105. For example, the CEK may simply be appended to the end of the advertisement message, or it may be inserted anywhere within the message. However, in the preferred embodiment of the present invention advertisement 105 is hashed to become the CEK. As one of ordinary skill in the art will recognize, hashing is a cryptographic operation that generates a small fingerprint of arbitrary-sized data. A hash algorithm may be unkeyed (e.g. the SHA-1 or the MD5 algorithm) or keyed (e.g. the IEEE P1363 HMAC algorithm). In another embodiment, the hash result is combined with the DRM public key 117 to produce the CEK.

By coupling advertisement 105 with digital content 103, advertisement 105 piggy-backs the same benefits as did digital content 103. For example, rules file 108 may forbid the user from modifying the digital content, which now includes advertisements. In alternate embodiments of the present invention, the DRM rules can contain a special rule, or constraint, explicitly for the rendering of the advertisement. In one embodiment, the rule may state that the advertisement must be rendered to completion (no bypassing, aborting, fast-forwarding, etc.). The state of the advertisement rendering is recorded in an Advertising Bit. This is an indication to the DRM system whether the rule for the advertisement was carried out to completion. In a full-blown example of DRM rules, the user may pay for the digital content package depending on how much advertising is embedded, the more he pays, the less advertising is included. It should be noted that the DRM rules may be optional. The default condition of the trusted rendering module may be to play the content, in which case the advertisement is first rendered to completion before obtaining the CEK to play the digital content. In this instance, metadata may be associated with the content that indicates the size of the required-to-be-rendered advertisement as well as a message to the user that the advertisement must be rendered in order to play the desired content.

So, for example, a user may have a choice to buy a full-price online video, or one at 1/4 price but with the caveat that several advertisements are interspersed in the content, much like a TV show. If the user chooses the latter, then the user is bound by the location of the various CEKs to fully render each advertisement to gain the ability to view the subsequent portion of the desired digitial content. This allows unsophisticated DRM systems (those without advanced rules functionality) to enforce the rendering of advertisements with minimal hardware/software support. Furthermore, the advertiser could potentially derive the benefit of a DRM system's ability to possibly record state information about how many times the digital content, and thus the advertising, has been rendered.

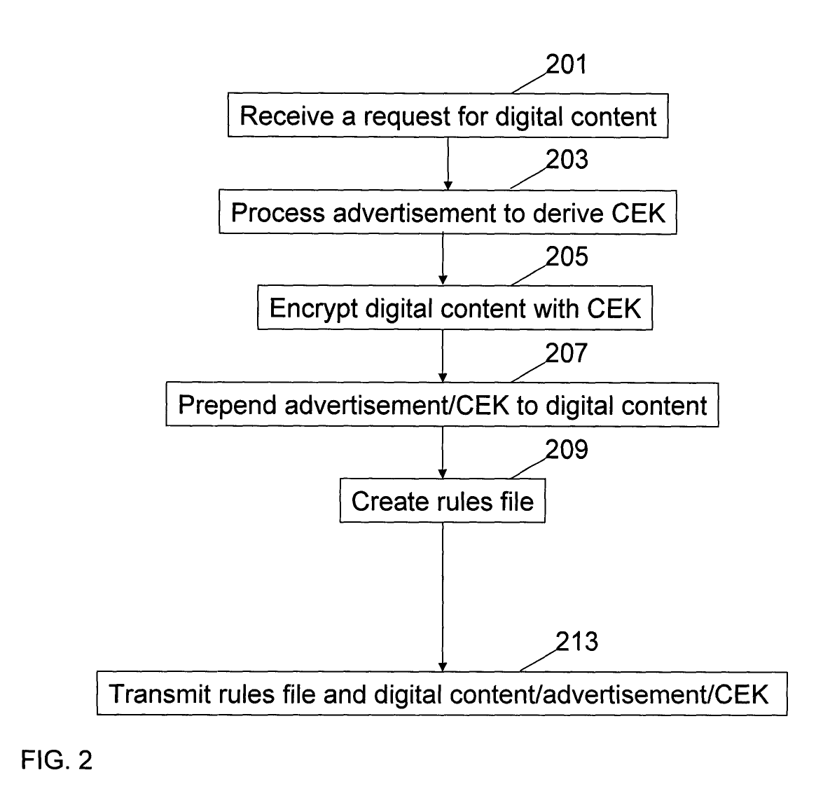

FIG. 2 is a flow chart showing operation of content provider 101. The logic flow begins at step 201 where a request for digital content (e.g., digital content 103) is received by logic circuitry 106. In response, logic circuitry 106 processes advertisement 105 to obtain a CEK (step 203) and encrypts digital content 103 with the CEK (step 205) to create encrypted digital content 109. Once the encrypted digital content and the advertisement/CEK combination are prepared, logic circuitry 106 prepends the advertisement/CEK to encrypted digital content 109 creating file 116 (step 207). At step 209 a rules file is optionally created by logic circuitry 106. As discussed above, rules file 108 may contain a length for advertisement 105 as well as DRM instructions for user equipment 102. File 116 and rules file 108 are transmitted to user equipment 102 at step 213.

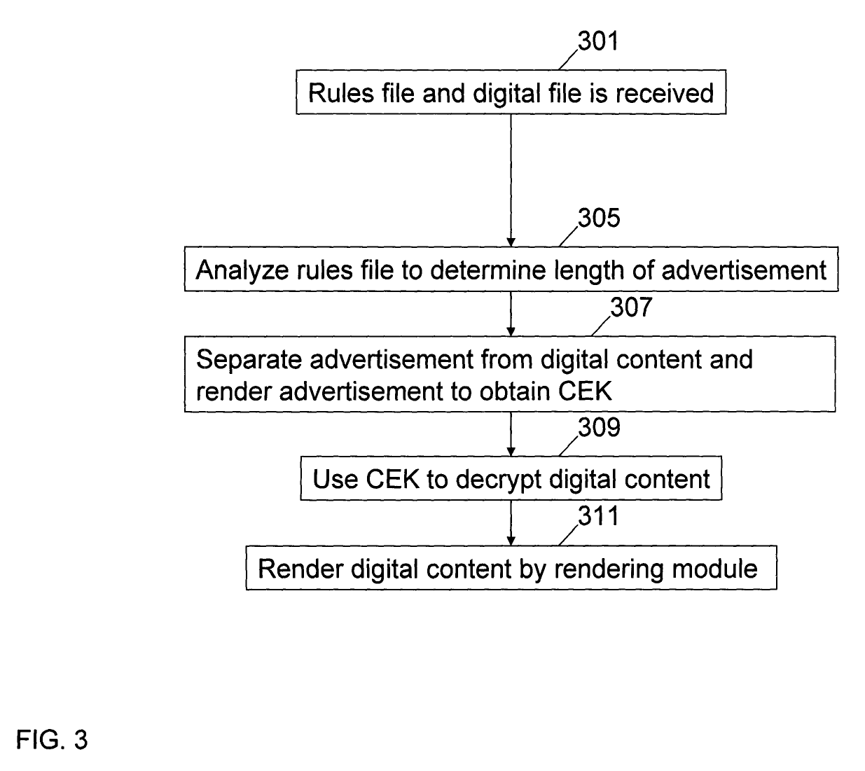

FIG. 3 is a flow chart showing operation of user equipment 102. The logic flow begins at step 301 where file 106 is received along with rules file 108. As discussed obove, file 106 comprises an advertisement along with encrypted digital content. Next, at step 305 DRM module 111 analyzes rules file 108 to determine a length of advertisement 105. Once the length of advertisement 105 is determined, advertisement 105 is separated from encrypted digital content 109 and rendered to obtain the CEK (step 307). During this procedure, rendering module 112 is utilized to render advertisement 105 so it is appropriately displayed/output by speaker 113/display 114. More particularly, DRM Module 115 uses this opportunity to obtain the CEK, as the preferred embodiment computes a cryptographic hash of the entire advertisement to determine the CEK. In another embodiment, the CEK may be derived based on the combination of the hash of the advertisement plus the DRM public key 117.

Continuing, at step 309 DRM module 111 utilizes the CEK to decrypt encrypted digital content 109 to get digital content 103. Finally, at step 311, the digital content 103 is passed to rendering module 112 where digital content 103 is rendered. As discussed above, DRM module 111 may also ensure that the advertisement is completely rendered, and report this information back to content provider 101.

While the invention has been particularly shown and described with reference to a particular embodiment, it will be understood by those skilled in the art that various changes in form and details may be made therein without departing from the spirit and scope of the invention. For example, although the above description was given with an advertisement message containing the CEK, one of ordinary skill in the art will recognize that any message that should be viewed may include the CEK as well. For example, it is easily envisioned that messages such as public service announcements, legal warnings, and commercials may be used to derive the CEK and prepended to the digital content. Additionally, the above description had the rules file indicating an advertisement length so that the advertisement can be properly “removed” from the transmitted file. In alternate embodiments, other mechanisms are utilized to determine the length of the advertisement. For example, the advertisement and encrypted digital content may be tagged with an XML tag indicating each section of the content package. In another embodiment, a special “stop hashing” character can be apendend to the advertisement, used to indicate an end of the advertisement. Alternatively, a special “begin” character can tell the application to use the hash of the previous value as a key starting at the next location. It is intended that such changes come within the scope of the following claims.

1. A method for rendering encrypted digital content, the method comprising the steps of:
obtaining data comprising an advertisement and encrypted digital content;
rendering the advertisement to obtain a content encryption key;
utilizing the content encryption key to decrypt the encrypted digital content; and
rendering the digital content.

2. The method of claim 1 wherein the step of obtaining data comprises the step of obtaining data comprising an advertisement, wherein the advertisement comprises information taken from the group consisting of a public service announcement, a legal warning, a commercial.

3. The method of claim 1 further comprising the step of insuring that the advertisement is completely rendered prior to rendering the digital content.

4. The method of claim 1 wherein the step of rendering the advertisement to obtain the content encryption key comprises the step of hashing the advertisement to obtain the content encryption key.

5. The method of claim 1 wherein the step of rendering the advertisement to obtain the content encryption key comprises the step of using a keyed hash algorithm on the advertisement to obtain the content encryption key.

6. The method of claim 1 wherein the step of rendering the advertisement to obtain the content encryption key comprises the step of hashing the advertisement and using a public key to obtain the content encryption key.

7. The method of claim 1 further comprising the steps of:
receiving a DRM rules file; and
analyzing the DRM rules file to determine a length of the advertisement.

8. A method for preparing an advertisement message, the method comprising the steps of:
creating an advertisement; and
determining a content encryption key (CEK) based on the advertisement, utilized to decrypt encrypted digital content

9. The method of claim 8 further comprising the steps of:
prepending the advertisement message containing the CEK to the encrypted digital content; and
transmitting the advertisement message containing the CEK and the digital content.

10. The method of claim 8 wherein the step of creating the advertisement comprises the step of creating an advertisement taken from the group consisting of a public service announcement, a legal warning, a commercial.

11. The method of claim 8 further comprising the steps of:
creating a DRM rules file comprising a length of the advertisement; and
transmitting the DRM rules file along with the advertisement.

12. The method of claim 8 further comprising the steps of:
appending a “stop hashing” value to the advertisement; and
transmitting the advertisement with the appanded “stop hashing” value;

13. An apparatus comprising:
a DRM module obtaining data comprising an advertisement and encrypted digital content, rendering the advertisement to obtain a content encryption key, and utilizing the content encryption key to decrypt the encrypted digital content; and
a rendering module rendering the digital content.

14. The apparatus of claim 13 wherein the advertisement comprises information taken from the group consisting of a public service announcement, a legal warning, a commercial.

15. The apparatus of claim 13 wherein the DRM module hashes the advertisement to obtain the content encryption key.

16. The apparatus of claim 15 wherein the DRM module uses a a keyed hash algorithm on the advertisement to obtain the content encryption key.

17. An apparatus comprising:
digital content;
an advertisement; and
logic circuitry for obtaining a content encryption key from the advertisement and encrypting the digital content with a content encryption key.

18. The apparatus of claim 17 wherein the advertisement is hashed to become the content encryption key.
